(19) United States
(12) Patent Application Publication
(10) Pub. No.: US 2007/0290765 A1
(43) Pub. Date: Dec. 20, 2007

(54) Connector structure

(75) Inventor: Yu-Chu Hsu, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Corporation, Taipei (TW)

(21) Appl. No.: 11/469,521

(22) Filed: Sep. 1, 2006

(30) Foreign Application Priority Data
Jun. 16, 2006 (TW) 095121736

(51) Int. Cl. H04B 3/28

(52) U.S. Cl. 333/12

(57) ABSTRACT

A connector structure suitable for a high-frequency signal transmission is provided. The connector structure includes a printed circuit board for transferring and processing high-frequency signals, and being electrically connected to a transmission cable, so as to transmit the signals. Here the electrical connection between the ground line of the transmission cable and the ground line of the circuit board must be avoided, so as to prevent high-frequency electromagnetic wave noise from being sent out together with the signals. In addition, an electromagnetic wave insulated absorbing material covers the circuit board, for attenuating the high-frequency electromagnetic wave noises generated by the circuit board. Finally, the transmission cable and the circuit board covered by an electromagnetic wave insulated absorbing material are accommodated within a metal case, thereby reducing the conduction impedance between the shells of the metal case, so as to eliminate the electromagnetic interferences (EMI).

### CROSS-REFERENCE TO RELATED APPLICATIONS

This non-provisional application claims priority under 35 U.S.C. § 119(a) on Patent Application No(s). 095121736 filed in Taiwan, R.O.C. on Jun. 16, 2006. the entire contents of which are hereby incorporated by reference,

### BACKGROUND OF THE INVENTION

1. Field of Invention

The present invention relates to a connector structure, and more particular, to a connector structure having an electromagnetic wave insulated absorbing material for attenuating the electromagnetic interference (EMI).

2. Related Art

Along with the increasing access of Internet network and the increasing complexity of network application, information network talents and network architecture managers must provide a fast network data transfer and interchange. In accordance with the increasingly requirements of higher transferring speed, the frequency of the transmitted signal is becoming higher. Therefore, the design of a high-frequency connector for enhancing the speed for transferring network data has become an important issue for the high-speed data transmission.

In the design of a conventional high-frequency connector, since the frequency of the signal transmitted on the printed circuit board is up to about 10 GHz, a high-frequency noise is generated. Since a potential difference exists between the circuit on the circuit board and the metal case covering the circuit board, a resonance phenomenon occurs between the high-frequency electromagnetic wave noise and the above metal case, such that an antenna effect occurs to the metal case, thus generating an electromagnetic interference (EMI) and negatively affecting the transfer quality of the initial signal. Therefore, how to solve the resonance problem of the high-frequency noise resulting from the high-frequency transmission signal has been the problem for the high-frequency connector to overcome.

Please refer to FIG. 1 of a top view of a conventional connector structure 10. As shown in FIG. 1 the connector structure 10 comprises a circuit board 12, a copper foil 17 covering the circuit board 12, a metal case 13, and a transmission cable 11 connected to the circuit board 12. When high-frequency signals are transmitted between the circuit board 12 and the transmission cable 11, the high-frequency electromagnetic wave noise is generated. Thus, a layer of copper foil 17 covers the circuit board 12, so as to achieve a metal shielding effect, thereby confining the high-frequency electromagnetic wave noises between the copper foil 17 and the circuit board 12 to prevent the noises from being transferred out of the circuit board 12. However, the signal transmitted by the connector structure 10 is a high-frequency signal (10G), the metal shielding effect for the electromagnetic wave is not as effective as that for the low-frequency signals, and thus cannot provide a good shielding effect. In addition, since the copper foil 17 is made of metal materials, when the high-frequency signals are transmitted between the circuit board 12 and the transmission cable 11, a potential difference is generated in the circuit of the copper foil 17 and the circuit board 12, and the potential difference induce a resonance of the high-frequency electromagnetic wave noises, thus enhancing the EMI phenomenon.

In the conventional art, both the ground line of the transmission cable 11 and a plurality of transmission cable signal lines are connected to the circuit board 12 of the connector structure 10, such that the ground line of the circuit board 12 is connected to the ground line of the transmission cable 11. Therefore, the high-frequency electromagnetic wave noises together with the high-frequency signals are also transferred to the transmission cable 11, and then transmitted, thus negatively affecting the quality of the high-frequency signal.

In addition, the metal case 13 is formed by a combination of two shells. Due to the limitation of the manufacturing module, the two shells of the metal case 13 cannot be closely bonded together, so that the conduction impedance increases, and thus noises easily occur and also EMI escapes.

In view of the above, the EMI problem of the high-frequency signal has always been a crucial issue in this field, and many issues are directed to obtain high-frequency signals with good quality. The present invention provides an improved connector structure for effectively solving the above problems.

### SUMMARY OF THE INVENTION

In view of the above problems, an objective of the present invention is to solve the EMI phenomenon of a high-frequency connector in the conventional art. The EMI phenomenon results from the resonance of high-frequency electromagnetic wave noises generated by a circuit board covered by a copper foil, and also results from the problems of the interference caused by the escaping of noises generated by an excessive impedance due to the slit of the metal case and the high-frequency electromagnetic wave noises transferred via the transmission cable.

In order to achieve the above objective, the present invention provides a connector structure suitable for a high-frequency signal transmission, which comprises a printed circuit board for transferring and processing high-frequency signals, and being electrically connected to a transmission cable, so as to transmit the signals out. In order to prevent the ground line of the transmission cable from being electrically connected to the ground line of the circuit board which may result in that high-frequency electromagnetic wave noises are transferred out together with the high-frequency signals, an electromagnetic wave insulated absorbing material covers the circuit board according to the present invention, for inhibiting the high-frequency electromagnetic wave noises generated by the circuit board.

The virtue of the present invention is that a rubber electromagnetic wave insulated absorbing material is used to cover the circuit board to significantly attenuate the EMI phenomenon. Through the design of the metal case with the connector structure, the two shells of the metal case are closely bonded together. Then, the two shells are tightly bonded by winding a conductive adhesive tape, such that the conduction impedance of the whole metal case is reduced, thus eliminating the noise problem caused by the high impedance of the case in the conventional design Furthermore, the two shells of the metal case are closely bonded together, and thus the problem that the EMI escapes to interfere other circuits can be solved. Also, through changing the way of wiring between the circuit board and the transmission cable, the ground lines of the circuit board and the transmission cable are respectively grounded and are not connected with each other, and thus the initial signal transmission will not be affected by the high-frequency electromagnetic wave noises.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein,

FIG. 1 is a top view of a conventional connector,

FIG. 2 is a top view of a connector structure with an electromagnetic wave insulated absorbing material of the present invention

FIG. 3 is a schematic cross-sectional view of a connector structure with an electromagnetic wave insulated absorbing material of the present invention

FIG. 4 is a side view of the first embodiment of the present invention, and

FIG. 5 is a side view of the second embodiment of the present invention.

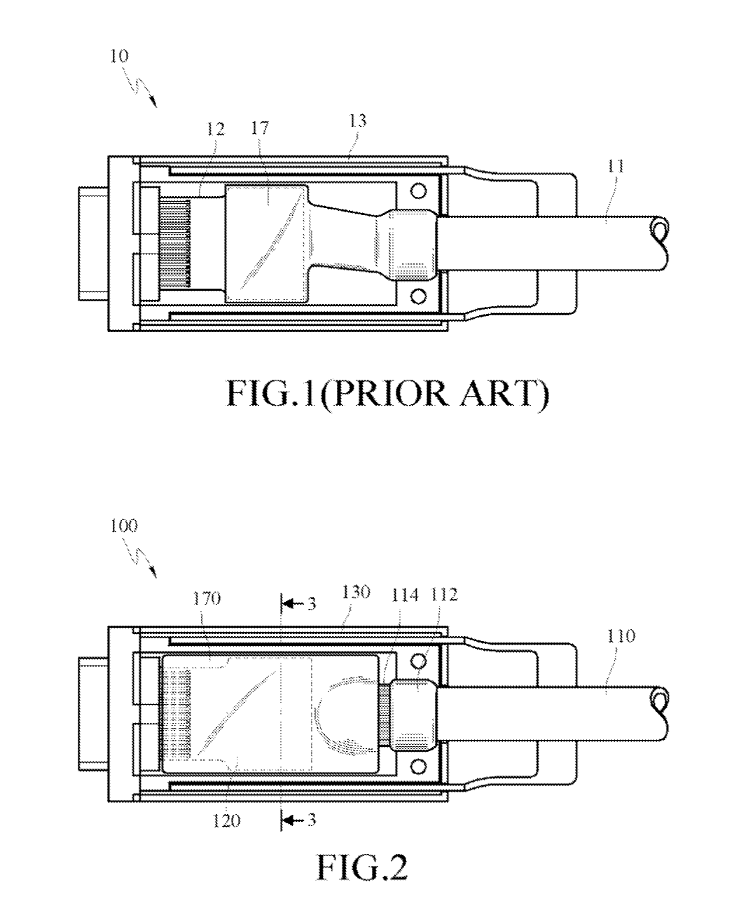

### DETAILED DESCRIPTION OF THE INVENTION

Please refer to FIGS. 2, 3, and 4 of schematic views of a connector structure according to the first embodiment of the present invention. As shown in FIGS. 2, 3, and 4, a connector structure 100 comprises a circuit board 120, a first metal shell 130, a second metal shell 140, a transmission cable 110, and an electromagnetic wave insulated absorbing material 170. The transmission cable 110 comprises a plurality of transmission cable signal lines 114 electrically connected to the circuit board 20. The electromagnetic wave insulated absorbing material 170 covers the circuit board 120 and the transmission cable signal lines 114 of the transmission cable 110, and is disposed between the first metal shell 130 and the second metal shell 140. In addition, the transmission cable signal lines 114 of the transmission cable 110 are provided with a metal ground joint 112 electrically connected to the first metal shell 130 and the second metal shell 140, so as to serve as a ground terminal for the transmission cable 110. When the first metal shell 130 and the second metal shell 140 of the present invention are bonded together, the present invention further provides a conductive adhesive tape 190 covering the first metal shell 130 and the second metal shell 140, such that the first metal shell 130 and the second metal shell 140 are closely bonded together.

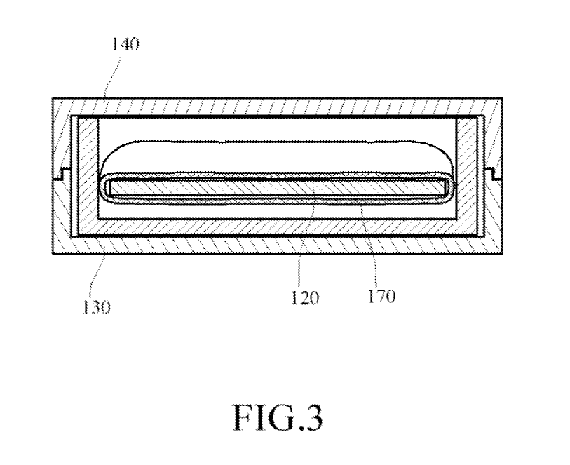

As shown in FIG. 3, the electromagnetic wave insulated absorbing material 170 covers the circuit board 120 and the electrical connection region of the circuit board 120 and the plurality of transmission cable signal lines 114, and is disposed between the first metal shell 130 and the second metal shell 140. The electromagnetic wave insulated absorbing material 170 completely covers two sides of the circuit board 120, and the electromagnetic wave insulated absorbing material 170 is partially overlapped, wherein about 20% of the electromagnetic wave insulated absorbing material 170 is overlapped to assure completely covering the two sides. The electromagnetic wave insulated absorbing material 170 of the present invention can attenuate the strength of the EMI caused by the high-frequency signals, and can attenuate the strength of the EMI field by over 50%. In addition, the electromagnetic wave insulated absorbing material 170 of the present invention can be a Rubber Absorber RS001A produced by RainSun Corporation, with a preferred thickness of 0.08 mm, and operates under a high-frequency of the 30 MHz-10 GHz, so as to achieve a good absorbing effect.

Furthermore, the connector structure 100 transmits out the high-frequency signals processed by the circuit board 120 via the transmission cable signal lines 114. In the first embodiment of the present invention, the ground line of the transmission cable 110 is connected to the metal ground joint 112 connected to the first metal shell 130 and the second metal shell 140, so as to achieve the grounding effect. And, the ground line of the transmission cable 110 is disposed separately from the ground terminal of the circuit board 120, so as to prevent the high-frequency electromagnetic wave noises generated by the circuit board 120 from being transmitted out via the ground line of the transmission cable 110, thereby assuring the transmission quality of the high-frequency signals.

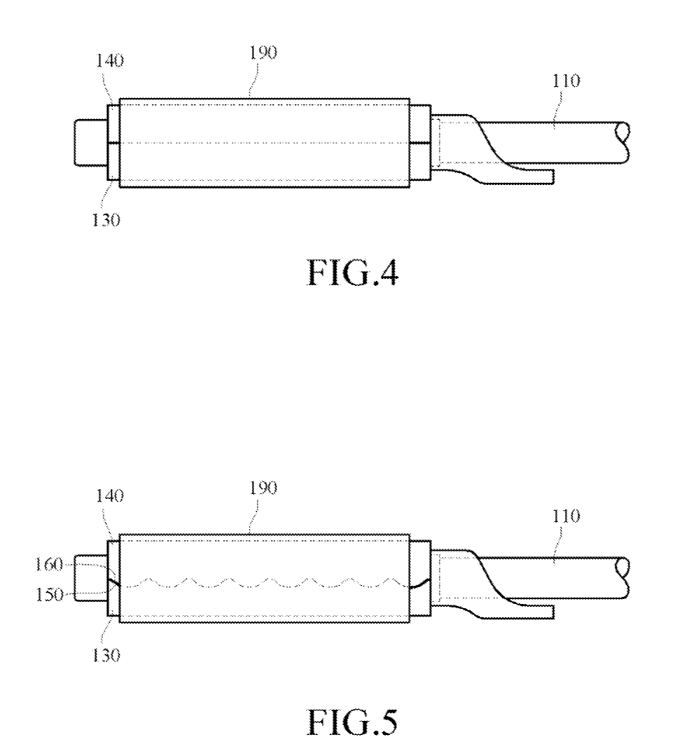

As shown in FIG. 4 according to the first embodiment of the present invention, the junction of the first metal shell 130 and the second metal shell 140 covering the circuit board 120 and the transmission cable 110 is a horizontally cut and closely bonded structure, such that the first metal shell 130 and the second metal shell 140 has a good electrical contact with each other, thereby reducing the potential difference between the first metal shell 130 and the second metal shell 140, that is, reducing the conduction impedance and preventing the interference of the electromagnetic wave from escaping through the slit of the shells. Furthermore, after the first metal shell 130 and the second metal shell 140 are bonded together, a conductive adhesive tape 190 is wound around or adhered to the junction of the first metal shell 130 and the second metal shell 140. In the present embodiment, the conductive adhesive tape 190 made of copper is used to make the first metal shell 130 and the second metal shell 140 have good electrical contact with each other, and also reduce the potential difference between the first metal shell 130 and the second metal shell 140, thereby reducing the conduction impedance and eliminating the resonance caused by the potential difference of the shells.

Please refer to FIG. 5 of a schematic view of a connector structure according to the second embodiment of the present invention. The main connector structure is the same as that of the first embodiment, and only difference therebetween is described herein. The junction of the first metal shell 130 and the second metal shell 140 is different from that of the first embodiment. The first metal shell 130 has a concave U-shaped edge 150, and the second metal shell 140 has a convex U-shaped edge structure 160. Therefore, when the first metal shell 130 and the second metal shell 140 are bonded together, the junction is a close concave-convex junction structure, such that the first metal shell 130 and the second metal shell 140 have a larger contact area and better electrical contact than that of the first embodiment, so as to reduce the potential difference between the first metal shell 130 and the second metal shell 140, thereby reducing the conduction impedance to prevent the interference of the high-frequency electromagnetic wave from escaping via the slit of the shells. Similarly, after the first metal shell 130 and the second metal shell 140 are bonded together, a conductive adhesive tape 190 is wound around or adhered to the junction of the first metal shell 130 and the second metal shell 140, so as to eliminate the resonance phenomenon caused by the potential difference between the first metal shell 130 and the second metal shell 140.

The present invention uses an electromagnetic wave insulated absorbing material 170 made of a rubber to cover the circuit board 120, which can greatly attenuate the field strength of the EMI, thereby modifying the contact surface of the two shells of the connector structure 100, and thus the shells closely contact each other. Then, a conductive adhesive tape 190 is wound around or adhered to the junction of the two shells, such that the conduction impedance of the overall connector structure 100 is reduced, thereby eliminating the noise problem caused by the high impedance of the case in the conventional design. In addition, the connector structure 100 of the present invention changes the way of wiring between the conventional circuit board and the transmission cable, such that the ground lines of the conventional circuit board and the transmission cable are respectively grounded and not connected to each other. Therefore, the high-frequency signal is not influenced by the high-frequency electromagnetic wave noise during the transmission.

The invention being thus described, it will be obvious that the same may be varied in many ways. Such variations are not to be regarded as a departure from the spirit and scope of the invention and all such modifications as would be obvious to one skilled in the art are intended to be included within the scope of the following claims.

What is claimed is:

1. A connector structure, comprising;
a circuit board;
a transmission cable having a plurality of transmission cable signal lines electrically connected to the circuit board:
an electromagnetic wave insulated absorbing material for covering the circuit board and the plurality of transmission cable signal lines; and
a first metal shell and a second metal shell, disposed corresponding to each other and bonded together, for accommodating the transmission cable and the circuit board covered by the electromagnetic wave insulated absorbing material.

2. The connector structure as claimed in claim 1, wherein the electromagnetic wave insulated absorbing material is an electromagnetic wave absorbing material which is made of rubber material.

3. The connector structure as claimed in claim 1, further comprising a conductive adhesive tape wound around or adhered to the junction of the first metal shell and the second metal shell.

4. The connector structure as claimed in claim 3, wherein the conductive adhesive tape is made of copper.

5. The connector structure as claimed in claim 1, wherein the junction of the first metal shell and the second metal shell are fabricated to be a concave U-shaped edge and a convex U-shaped edge, respectively.

6. The connector structure as claimed in claim 1, further comprising a metal ground joint bonded to the first metal shell and the second metal shell for accommodating the plurality of transmission cable signal lines.
